(19) United States
(12) Patent Application Publication
(10) Pub. No.: US 2011/0156405 A1
(43) Pub. Date: Jun. 30, 2011

(54) WIND POWER STATION

(76) Inventor: Patrik Holm, Vaasa (FI)

(21) Appl. No.: 13/060,950

(22) PCT Filed: Sep. 10, 2009
(86) PCT No.: PCT/FI09/00083

§ 371 Date: Feb. 25, 2011

(30) Foreign Application Priority Data
Sep. 10, 2008 (FI) 2008-0510

(51) Int. Cl. H02P 9/04

(52) U.S. Cl. 290/55

(57) ABSTRACT

Wind power station, which comprises a vertical tower (1), the rotor of the power station fitted to the top end of the tower and aligned towards the wind, which rotor comprises blades and also a hub part that supports the aforementioned rotor, which hub part comprises a hub frame (4) that revolves around an essentially vertical axis resting on bearings (5, 6), as well as the necessary components connected to the aforementioned hub frame (4), such as a rotating shaft for the aforementioned rotor blades, bearings for the aforementioned rotating shaft, a possible generator arrangement, and also a rotator arrangement of the hub frame (4), by means of which the rotor is aligned towards the wind. The rotator arrangement of the hub frame (4) comprises a brake disc/flange ring (8) fixed either to a non-rotating tower (1) or to an extension (2) of it, or alternatively to a revolving hub frame (4), onto the surface of which brake disc/flange ring a number of gripping means (13) are arranged to press and to move to new positions on the surface of it such that by means of movable rods, such as hydraulically lengthening or shortening cylinders (11), leaving the aforementioned gripping means (13) a rotary motion can be achieved between the aforementioned flange ring (8) and the frame part (4) or (1, 2) of it, to which the second ends of the movable rods are fixed.

The invention relates to a wind power station, which comprises a vertical tower, the rotor of the power station fitted to the top end of the tower and aligned towards the wind, which rotor comprises blades and also a hub part that supports the aforementioned rotor, which hub part comprises a hub frame that revolves around an essentially vertical axis resting on bearings, as well as the necessary components connected to the aforementioned hub frame, a rotating shaft for the aforementioned rotor blades, bearings for the aforementioned rotating shaft, a possible generator arrangement, and also a rotator arrangement of the hub frame, by means of which the rotor is aligned towards the wind.

Known from prior art are wind power stations in which the alignment of the rotor blades and the other apparatuses of the top part of the tower, such as the rotor shaft, occurs either by rotating the whole tower on a base on the surface of the ground or with a bearing fitted to the top part of the tower, resting on which bearing the top part can be rotated around the vertical axis according to the wind. If the whole tower of the wind power station turns, a bearing that enables rotation of the tower must be made in the base in the proximity of the ground surface. If the tower is fixed and only the unit at the end of the tower is rotated, an appropriate bearing must be fitted to the top end of the tower. In prior-art solutions a gear ring, and generally also a gear driven by an electric motor or by a hydraulic motor, as well as a gear wheel as an output of it disposed in contact with the gear ring, is fitted in connection with these bearing points. A number of these geared motors and gear wheels are distributed on the gear rim.

A drawback of the prior-art solutions described above is that braking of the rotation of the gear ring, much less locking of the rotation, is not achieved in rotation that occurs with a electric motor because the electric motor can even rush at overspeed if the wind powerfully assists the turning of the top part of the wind power station. However, when using braked motors braking of the rotation is achieved, but the effect of it is transmitted via the gearbox to the gear rim. The gear is thus loaded when braking. The greatest drawback with this solution is the tooth flank clearance of the gearing, which clearance is in a number of places in the gearbox and which is multiplied owing to the transmission ratio.

The effect of the clearance is prevented by means of a brake disc and brake shoes that press against it on the gear ring side, which braking prevents the occurrence of free play resulting from the clearance. Driving geared motors with the brakes on, in which case the motors are dimensioned to rotate the hub part with the brakes on, is also known from prior art. In these cases geared motors no longer manage to revolve the hub part, if the hub part must be turned against a stronger wind. A gust of wind may then rotate the hub part and the motors rush at overspeed.

Locking of the rotation of the gear ring can certainly be achieved by using a worm gear in between, but in this case a considerable clearance develops between the motor and the gear ring, such as e.g. when using a transmission ratio of 1:1000. The braking torque produced with a motor is significantly large compared to the torque tolerance of the other part of the gear and so the gearing and the gear become overloaded.

When using a hydraulic motor the drawbacks described above are repeated. The rotary motion of the top part cannot be achieved without clearance with motor drives in both directions. If the situation is such that the top part even turns by itself, then sometimes there is braking with the motor and sometimes driving, and damage caused by the clearance will certainly occur.

To eliminate the aforementioned drawbacks a new wind power station has been developed, in which the following ideas are implemented:
A system is made in which there are no clearances and in which none will any develop. If a clearance develops in a joint, it is possible to eliminate it with cylinder forces, which can be used in both directions.
A system is made that is able to rotate the hub part in a strong wind as long as the turbine is in production, up to a wind speed of approx. 25 m/s and to brake in a 50 m/s storm.
A system is made that is able to brake in all conditions, also in an emergency if no electricity is available.
A system in which it is possible to replace all the components of the system from above in the hub part.

The new wind power station according to the invention is characterized in that the rotator arrangement of the hub frame comprises a flange ring, which functions as a brake disc and gripping disc, fixed to a non-rotating tower or to an extension of it, or alternatively to a revolving hub frame, onto the surface of which flange ring a number of gripping means are arranged to press and to move to new positions on the surface of it such that by means of movable rods, such as hydraulically lengthening or shortening cylinders, leaving from the aforementioned gripping means a rotary motion can be achieved between the aforementioned flange ring and the frame part of it, to which the second ends of the movable rods are fixed.

An advantage of the wind power station according to the invention is that also very slow alignment motion of the hub part can easily be achieved. The hub part can be locked into its position with the same apparatus as with which the rotating occurs. Large and expensive gear rims are not needed. The flange ring is either an integral ring or assembled from parts, in which case delivery in parts when replacing it makes installation decidedly easier. Also the hydraulic cylinders are relatively cheap and reliable in practice. The control arrangement of the cylinders is also easy to implement. The apparatus can be installed in the proximity of the bearings or in another location, which is independent of them, in the hub part.

In the following, the invention will be described in more detail with reference to the attached drawing, wherein

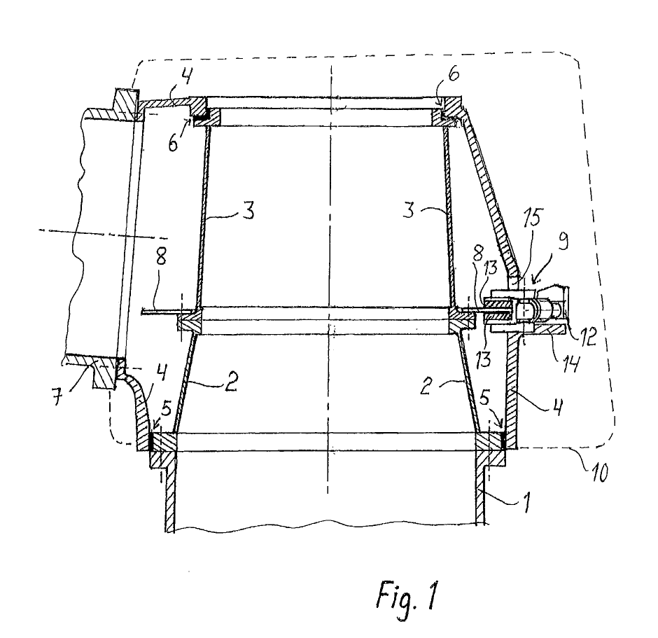

FIG. 1 presents a sectioned view of a rotator apparatus of the top part of a wind power station, connected to the top part of the tower.

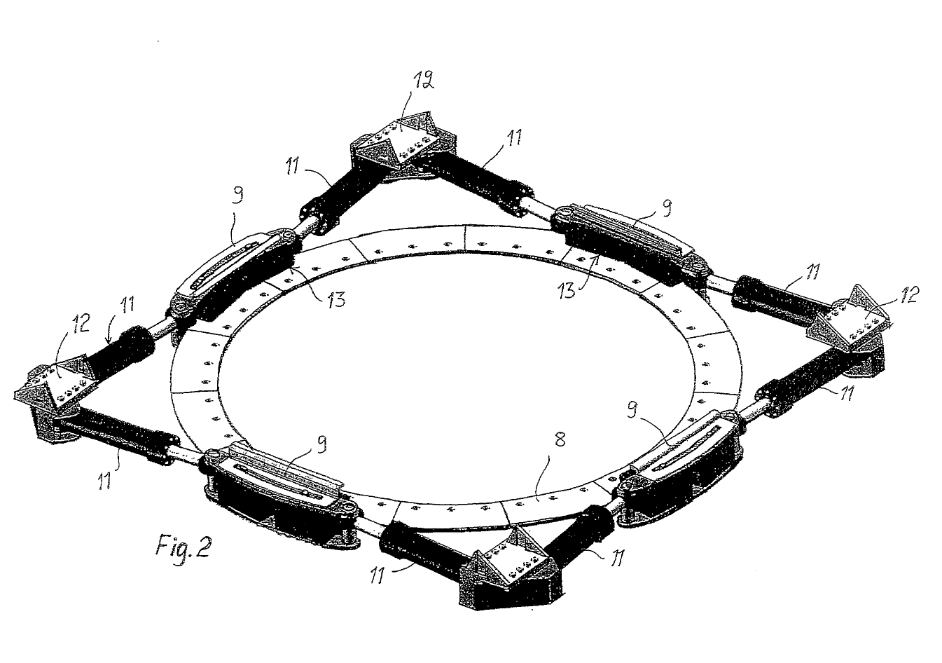

FIG. 2 presents an oblique view of a brake disc/flange ring and a rotator apparatus.

FIG. 1 presents a first extension 2 of the tower fixed securely to the top part of the non-rotating tower 1 of the wind power station, and above it also a second extension 3. By means of the bearings 5 and 6 the rotating hub part 4 is connected to the outside of the non-rotating section, in which hub part a fixing flange and a bearing housing 7 in it for the shaft are formed, supported by which shaft the rotating part of the generator and also the wind rotor rotate. The hub part 4 further comprises a protective shell, the position of which is presented with dashed lines.

In this embodiment turning of the hub part 4 in relation to the tower 1 and its extensions 2, 3 occurs by means of a rotator device 8, 9, 11, 12. The rotator device comprises a brake disc/flange ring 8, assembled from parts, which is fixed to the non-rotating extension of the tower 1. The flange ring 8 is gripped with the gripping means 13 of the rotator device by pressing the means against the flange ring. The other parts of the rotator device are fixed to the hub frame 4, with which parts the relative rotary motion needed between the flange ring 8 and the hub part 4 is achieved. The gripping means 13 are pressed against the flangering 8 e.g. by means of pressure vessels or low, short-stroke hydraulic cylinders. The gripping means are in practice brake shoes. Also the brake shoes can in a certain case be separate e.g. stationary additional brake shoes controlled to brake, in which case the gripping means 9, 13 are gripping means that are controlled and moved separately to each other.

FIG. 2 presents four gripping means units 9 that are symmetrically disposed and that comprise friction surfaces 13 as well as a compressing means, with which the friction surfaces 13 are pressed against both the flange surfaces of the flange ring 8. The brake shoe/compression device is e.g. a floating structure, i.e. a fixed jaw on one side and a hydraulically movable second jaw on the other side.

Rods implemented by means of hydraulic cylinders 11 leave the gripping means units 9 to four fixing pieces 12, by means of which the outer ends of all eight hydraulic cylinders are supported on the hub part 4. The gripping means/brake shoes are force-controlled. In FIG. 2 they are controlled with the pin-in-groove method, in which case even if in the open state they stay at the point intended for them on the flange ring 8.

FIG. 1 shows a widening 14 formed in the hub part 4 on the outer edge of it, onto the top of which the fixing parts 12 are fixed. There are four evenly-spaced widenings 14, as also there are fixing parts 12. The widening 14 can be single-sided or double-sided. When the flange ring 8, for its part, is on the inside of the hub part 4, apertures 15 are formed in the hub part 4 for the cylinders 11, through which the cylinders are disposed inside the hub part 4 such that the second end of them is in the gripping unit 9.

The hydraulic cylinders 11 of FIG. 2 are controlled so that a mutual rotary motion between the flange ring 8 and the hub part 4 is achieved with them. All the gripping units 9 are compressed. Of the cylinders 11, four are push-action and four are pull-action. When the margin of movement of the cylinders 11 ends, they are moved, e.g. one at a time, to a new position on the flange ring 8 by opening the compression of the gripping means 13 during the move. Thus, three are sufficient keep it in its position when it is in operation. When it is parked in a storm, all 4 are needed. By means of the cylinders 11, the slow and stable rotary motion needed for the hub part 4, and also locking of the hub part by closing the valves of the cylinders, is achieved. The flange ring 8 is formed of segment parts and is easy to install and, if necessary, replace. The flange ring can be one-piece when new, segmented as a spare part.

Instead of hydraulic cylinders, also other actuators that make a mechanical linear movement can be used, such as screws rotated with a motor.

1. Wind power station, which comprises a vertical tower (1), the rotor of the power station fitted to the top end of the tower and aligned towards the wind, which rotor comprises blades and also a hub part that supports the aforementioned rotor, which hub part comprises a hub frame (4) that revolves around an essentially vertical axis resting on bearings (5, 6), as well as the necessary components connected to the aforementioned hub frame (4), such as a rotating shaft for the aforementioned rotor blades, bearings for the aforementioned rotating shaft, a possible generator arrangement, and also a rotator arrangement of the hub frame (4), by means of which the rotor is aligned towards the wind, characterized in that the rotator arrangement of the hub frame (4) comprises a brake disc/flange ring (8) fixed either to a non-rotating tower (1) or to an extension (2) of it, or alternatively to a revolving hub frame (4), onto the surface of which brake disc/flange ring a number of gripping means (13) are arranged to press and to move to new positions on the surface of it such that by means of movable rods, such as hydraulically lengthening or shortening cylinders (11), leaving the aforementioned gripping means (13) a rotary motion can be achieved between the aforementioned flange ring (8) and the frame part (4) or (1, 2) of it, to which the second ends of the movable rods are fixed.

2. Wind power station according to claim 1, characterized in that the brake disc/flange ring (8) is fixed to the non-rotating section of the tower (1) and to protrude from it.

3. Wind power station according to claim 1, characterized in that the brake disc/flange ring (8) is fixed to the rotating hub frame (4) and as a flange pointing inwards from it.

4. Wind power station according to claim 1, characterized in that the rotary motion achieved by means of the movable rods and the gripping means (13) pressed against the flange ring (8) is limited and the control arrangement of the rotary motion comprises an action in which the gripping means (13) can be moved to new pressing positions on the flange ring (8) to achieve an added margin of movement.

5. Wind power station according to claim 3, characterized in that the control arrangement comprises a function for moving one or more gripping means (13) at a time to a new position.

6. Wind power station according to claim 1, characterized in that both a push-action and a pull-action cylinder (11) is fixed to the gripping means (13).

7. Wind power station according to claim 1, characterized in that the brake shoe/gripping means (13) comprises an actuator, such as a hydraulic cylinder, which presses the friction surface of the gripping means against the flange ring (8).

8. Wind power station according to claim 1, characterized in that the flange ring (8) is assembled from segment parts.

9. Wind power station according to claim 1, characterized in that in the compression arrangement of the brake shoe/gripping means (13) the flange ring (8) is pressed between friction pads
